(19) United States
(12) Patent Application Publication
(10) Pub. No.: US 2006/0224623 A1
(43) Pub. Date: Oct. 5, 2006

(54) Computer status monitoring and support

(75) Inventors: Bradley John Graziadio, Redmond, WA (US); Ganesh Pandey, Kirkland, WA (US); Douglas Shawn Cavit, Arlington, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/097,763

(22) Filed: Apr. 2, 2005

(51) Int. Cl. G06F 17/00

(52) U.S. Cl. 707/104.1

(57) ABSTRACT

A root silo that authorizes one or more clients to access one or more services at one or more servicing silos receives a request from a client for interaction with a service. The root silo identifies a servicing silo as an available provider of the service for interacting with the client and generates a servicing certificate that contains (i) service entitlement information showing that the client is entitled to interact with the service at the servicing silo, (ii) location information identifying a location of the servicing silo, and (iii) one or more keys for use in secure communication between the client and the servicing silo. Having generated the servicing certificate, the root silo sends the servicing certificate to the client for the client to use when interacting with the service at the servicing silo.

### CROSS-REFERENCE TO RELATED APPLICATIONS

N/A

### BACKGROUND OF THE INVENTION

1. The Field of the Invention

The present invention relates to providing technical support. More specifically, the present invention relates to monitoring the operation of a client computer for use in providing technical support to the client.

2. Background and Related Art

For many, technical support takes one of two forms: telephone support or in-person support. Telephone support can be difficult because the all interaction with the client system requiring support occurs through a user of the client system. Among other things, interacting with the client system through a user is problematic because different users have differing levels of computer skills, it can be time consuming to relay information through the user, it is not possible for the person providing support to see any visual representation of information related to the client system, the user may inadvertently provide inaccurate information, and so forth.

Naturally, the direct interaction with a client system that in-person support affords is not subject to the limitations noted above with respect to telephone support. However, due to the increased cost associated in-person support, it is usually impractical for individual users outside of a business setting to receive in-person support. Furthermore, even in a business setting it may not be possible to receive in-person support for all problems and/or within a short period of time.

Although in-person support may be preferable to telephone support in terms of efficiently identifying and correcting problems, both telephone and in-person support tend to focus on problems only after they occur, as opposed to preventing the problems from occurring in the first place. Inexperienced and unsophisticated users are particularly vulnerable since they are more likely to miss warning signs of an impending problem or fail to appreciate the significance of warning signs that are observed. As a result, minor problems with relatively simple solutions are not addressed until they become more significant problems with relatively more complex solutions.

Accordingly, methods, systems, and computer program products for tracking one or more support parameters for use in providing technical support to a client subscriber are desired.

### BRIEF SUMMARY OF THE INVENTION

The present invention relates to methods, systems, and computer program products for a distributed service delivery model in which a service provider of a desired service may be identified and a client may be entitled to interact with the service, without the client being required to authenticate to an authorization component each time the client interacts with the service.

It should be noted here that the term “client” generally refers to a machine, such as a personal computer, but also may be used to refer to a user of the machine and/or a combination of the machine and a user of the machine. In a similar manner, the term “subscriber” generally refers to a user of the machine, but also may be used to refer to the machine itself and/or a combination of the machine and a user of the machine.

In accordance with an example computer program product embodiment of the present invention for monitoring operation of a client in connection with providing technical support to the client, the client sends registration information to a support service for registering a user as a subscriber with the support service for the client. The subscriber also identifies a support contact to the support service. The monitoring includes tracking one or more support parameters at the client, which uploads the one or more support parameters to the support service for analysis and distribution to the support contact. Based on the one or more support parameters uploaded to the support service, the client receives support data, from the support service, that includes one or more support actions as determined by the support contact identified by the subscriber, and takes the one or more support actions. Monitoring in this manner allows the subscriber to enjoy much of the benefits associated with in-person support, without the corresponding expense, and allows for proactive solutions to be taken for less serious or potential problems before the condition becomes more serious.

In accordance with another example computer program product embodiment of the present invention, for tracking one or more support parameters to use in providing technical support to a client subscriber, a support service registers a user as a subscriber with the support service for the client. The support service associates one or more support contacts with the subscriber. These one or more support contacts are identified by the subscriber. The support service accumulates one or more support parameters from the client and provides the one or more support parameters to the one or more support contacts. From the support contacts, the support service accumulates one or more support actions that are in response to the one or more support parameters, generates support data that includes the one or more support actions, and provides the support data to the client.

In accordance with an example support service embodiment of the present invention, that communicate information between a plurality of clients and one or more support contacts providing technical support to the plurality of clients, the support service includes a network interface for communicating with the one or more clients and the one or more support contacts, and one or more computer readable media with computer executable instructions. The computer executable instructions include instructions for registering a user as a subscriber with the support service for a client, instructions for assigning one or more support contacts to the subscriber, and instructions for receiving one or more support parameters from the client. It should be noted that ordinarily, the one or more support contacts are authenticated before being allowed access to the client's one or more support parameters. The computer executable instructions also include instructions for sending the one or more support parameters to the one or more support contacts, instructions for receiving one or more support actions from the one or more support contacts based on the one or more support parameters, and instructions for sending the one or more support actions to the client. A processing unit coupled to the network connection and the one or more computer readable media sends and receives data over the network connection, and executes the computer executable instructions.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims and this description. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered as limiting its scope, the invention will be described and explained with additional specificity and detail through the use of the accompanying drawings in which:

FIG. 1 illustrates a high-level block diagram for an example distributed computing system environment suitable for practicing the present invention;

FIG. 2 is state diagram for various entities within the distributed computer system environment illustrated in FIG. 1;

FIG. 3 is a state diagram for a subscriber in accordance with the present invention;

FIG. 4 is a state diagram for a support contact in accordance with the present invention;

FIG. 5 is a block diagram of an example support service in accordance with the present invention;

FIG. 6 is a block diagram showing additional detail for distributed computing system environment illustrated in FIG. 1;

FIG. 7 is a block diagram of an example client in accordance with the present invention; and

FIG. 8 illustrates an example computer system that provides a suitable operating environment for various embodiments of the present invention.

### DETAILED DESCRIPTION OF THE PREFERRED EMBODIMENTS

The present invention relates to methods, systems, and computer program products for monitoring the operation of a client computer for use in providing technical support to the client. In addition to those embodiments specifically described, the present invention may be embodied in other specific forms without departing from its spirit or essential characteristics. The described example embodiments are to be considered in all respects only as illustrative and not restrictive. The scope of the invention is, therefore, indicated by the appended claims rather than by this description. All changes which come within the meaning and range of equivalency of the claims are to be embraced within their scope.

### I. Overview

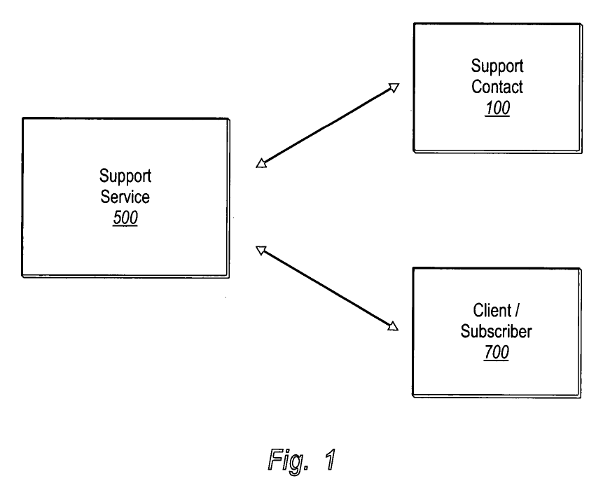

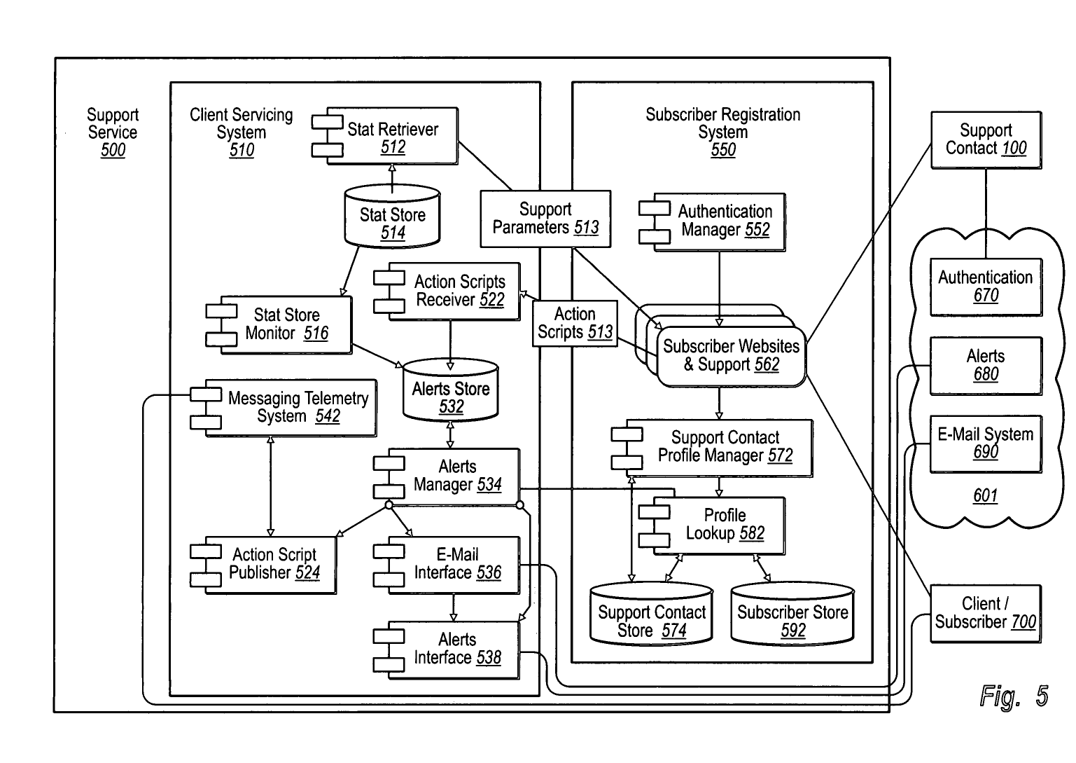

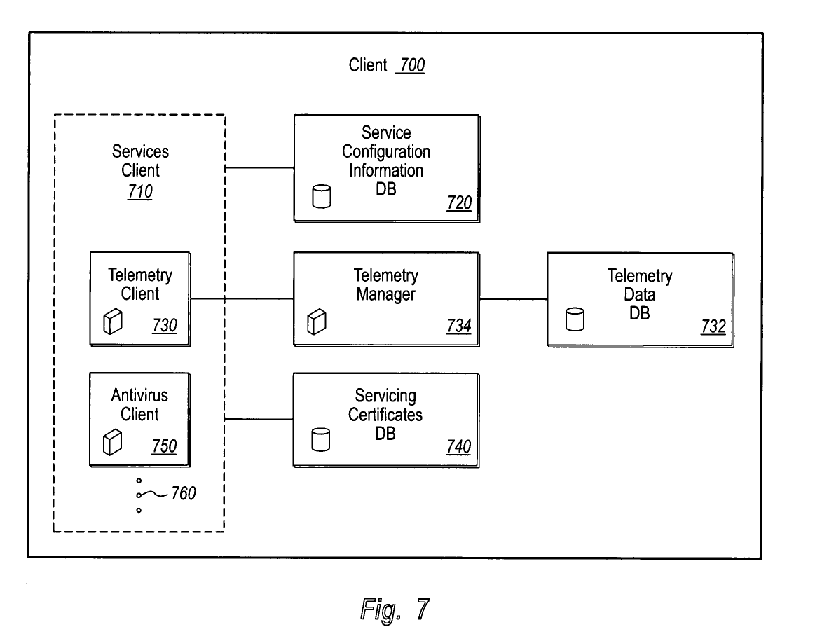

FIG. 1 illustrates a high-level block diagram for an example distributed computing system environment suitable for practicing the present invention. FIG. 1 shows a client/subscriber 700, a support contact 100 that provides technical support to the client/subscriber 700, and a support service 500 that communicates information between the client/subscriber and the support contact. As noted above, the term “client” generally refers to machine, such as a personal computer, but also may be used to refer to a user of the machine and/or a combination of the machine and a user of the machine. In a similar manner, the term “subscriber” generally refers to a user of a machine, but also may be used to refer to the machine itself and/or a combination of the machine and a user of the machine. Support service 500 is described in more detail in connection with FIG. 5 and client/subscriber 700 is described in more detail in connection with FIG. 7.

In an example embodiment described in more detail below, support service 500 provides a web-based view of a computer's health status and recent activity for subscribers and their appointed support contacts. Of course, health/security status represents merely one example of the type of support that the support contact and/or support service may provide to a subscriber. Accordingly, it should be recognized and understood that the health/security status embodiment described below is used simply to illustrate various aspects of the present invention that may or may not be present is other embodiments, and are not intended to limit the scope of the present invention, which is defined by the appended claims.

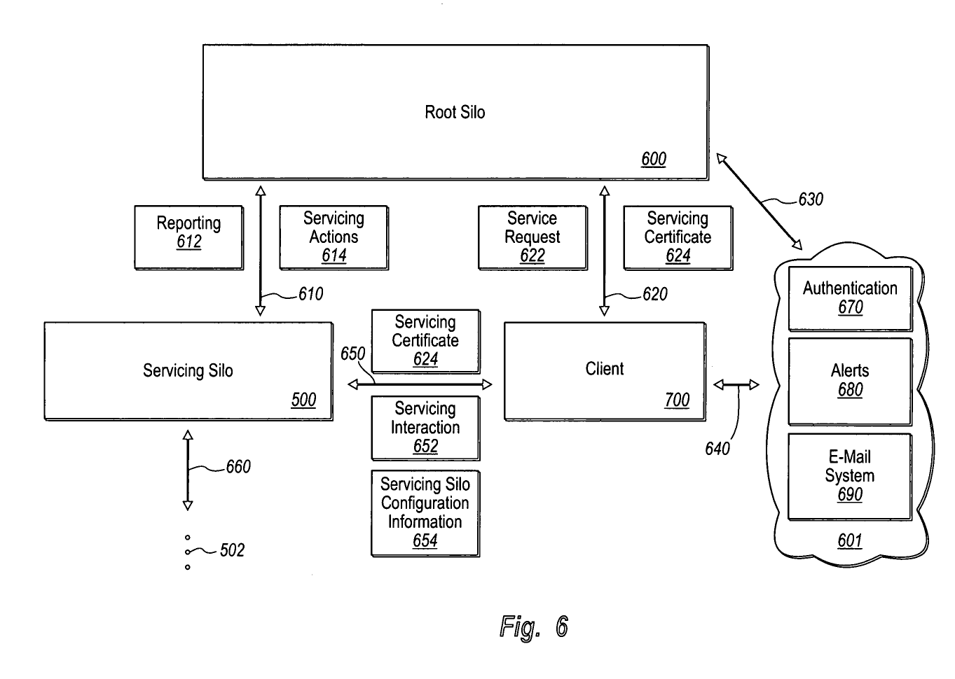

The support service also provides a notification channel for sending alerts to a support contact based on changes occurring at a client machine. As described in greater detail below in connection with FIG. 6, the system takes advantage of machine certificates to authenticate machines in order to prevent fraudulent use of the architecture. In some implementations, the architecture may form the basis of an eco-system of companies that provide paid support services for end-user machines, as well as providing a management system for small businesses to track their security posture. Among other things, the system makes it possible to run remote security scanning, tune-up and system diagnostics, in order to discover and resolve problems.

The architectural model can be broken down into subscriber activities, support contact activities, and other activities, depending on the particular implementation. For example, subscriber activities may include viewing all client machines and their status, viewing machine details, listing all support contacts and their status, inviting a support contact, removing a support contact, and so forth. Support contact activities may include viewing all subscribers and their machines, viewing machine details, changing profile and preference information, removing a subscriber, scheduling actions to be performed at a client, and the like. Other activities may include sending notifications or alerts when a certain predefined event occurs, authentication, etc. The following example scenarios are useful in providing additional details for these activities. For reference to an example implementation, refer to the example support service 500 illustrated in FIG. 5, the example distributed computing system environment for support illustrated in FIG. 6, and the example client illustrated in FIG. 7.

As described below in connection with FIGS. 5, 6, and 7, the client periodically sends telemetry data to the support service. The telemetry data includes, but is not limited to, the support parameters that are to be monitored by the support contact. It should also be emphasized that support service 500 may provide a variety of other services for client/subscriber 700 or may be limited to technical support.

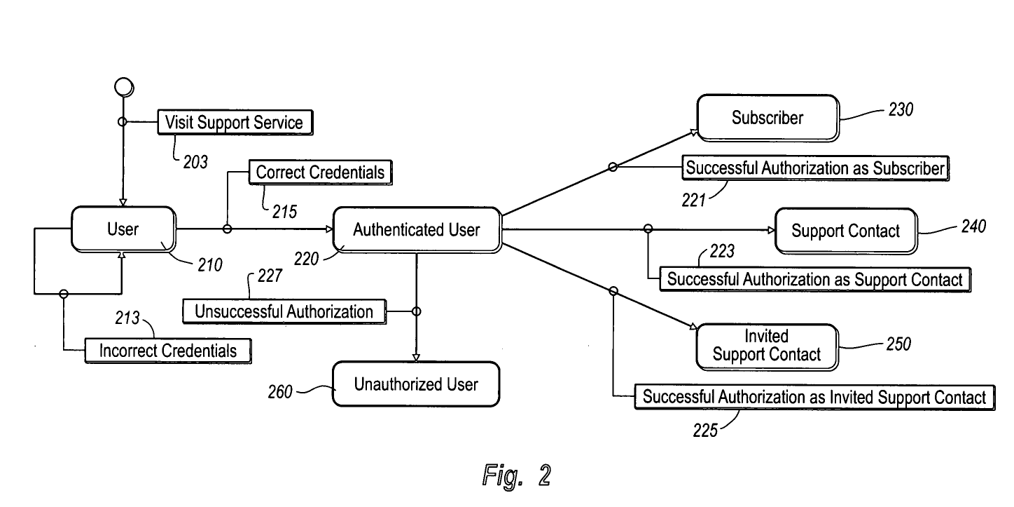

FIG. 2 is state diagram for various entities within the distributed computer system environment for support illustrated in FIG. 1. Initially, a user visits 203 the support service website. Prior to authentication, the user is simply identified as user 210. If the user provides incorrect credentials 213, the user remains a user 210. Upon providing correct credentials 215 the user 210 becomes an authenticated user 220. Authentication merely identifies who the user is. As shown by unsuccessful authorization 227, an authenticated user may not be authorized for any activities, and therefore after authentication, be identified as unauthorized user 260.

Generally, however, the user will be authorized in some manner. For example, following successful authorization as a subscriber 221, the authentication user will be designated as a subscriber 230. Following successful authorization as a support contact 223, the authenticated user will be designated as a support contact 240. Following successful authorization as an invited support contact 225, the authenticated user will be designated as a support contact 250.

As shown below in FIG. 5, using support service 500 to authenticate a support contact 100 in order to access support parameters and/or perform actions allows support service 500 to track and audit the activities of support contact 100. In contrast, direct authentication with the subscriber does not allow for the centralized tracking and auditing that the support service may provide in certain embodiments. Among other things, this centralized tracking and auditing allows the support service to assure that subscriber 100 receives an appropriate level of support. For example, upon discovery, a rogue or compromised support contact for multiple subscribers could be terminated at the support service, without each of the subscriber having to take action individually.

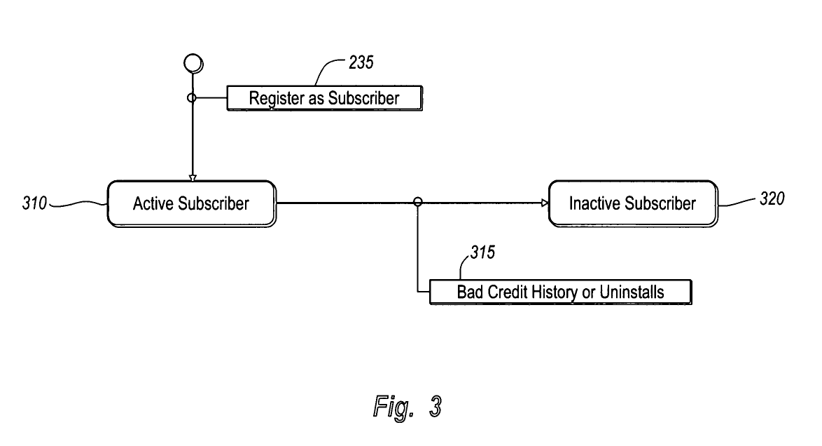

FIG. 3 is a state diagram for a subscriber. In order to become a subscriber, a user registers with the support service. Registration involves providing the required information to participate as a subscriber, which may vary from one implementation to another. In a paid support environment, registration typically includes providing sufficient information to identify the subscriber and perhaps a credit card for billing purposes. In other implementations, it may not be necessary to provide anything other than an email address, instant message address, or other identifier. As shown in FIG. 3, following registration, the subscriber may be designated as an active subscriber. It should be noted that generally, when the term “subscriber” is used in this application, it refers to an active subscriber. If an active subscriber has a bad credit history or uninstalls software 315 at the client needed to participate as a subscriber, the subscriber is designated as an inactive subscriber 320.

Is the subscriber secure? The support contact wants to know if the subscriber is secure. Accordingly, the support contact goes to a support area of a support website within subscriber registration system of a support service and signs in using an authentication manager. In this implementation, a third-party authentication mechanism provides authentication services. Through the support website, the support contact is able to see the state, in the form of one or more security parameters, of the subscriber's machine. Example security parameters include whether virus protection is on, whether virus protection is up-to-date, whether firewall protection is on, whether critical operating system and other software updates are installed and up-to-date, when the state was last updated, etc. The security parameters may be presented in the form of a health meter rating, with more detail for any health problem. For example, the health meter could use colors (e.g., green, yellow, red) or a number scale to provide an overall indication of the client.

Is there anything about which the support contact should worry? The support contact wants to know if the things that should be happening on the subscriber's machine are in fact happening. The support contact also wants to know if there has been any recent activity on the subscriber's machine that might decrease the subscriber's security and protection. By clicking of a details link for recent activity for the subscriber's machine and is able to see when the last virus scan was performed, was the machine cleaned, when was the last antivirus signature update, when was the last backup completed, when did the machine last send data to the support service, and so forth.

Recent critical alerts. The support contact wants to know about changes to the health meter and to see if any action items the subscriber was supposed to perform have occurred. The website shows the meter rating changes and the reasons associated with the changes for the last week (or alternatively a set number of the most recent changes). Depending on the support contact's preferences, the support contact may receive an alert notification for health meter changes, such as through an email or text message.

The subscriber wants to know the security status and recent activity on all machines in the subscription account. The subscriber goes to subscriber area of website 562 and signs-in using authentication manager 552. Here too, the third-party authentication 670 authenticates the subscriber. The subscriber is shown a list of all the clients included in the subscription. For each client, the website includes a link to view the per-machine status, recent activity, and recent alerts. The information available to the subscriber may be the same as the information available to the support contact as described in the foregoing scenarios. In some implementations, the number of machines included in a subscription is likely to be limited, since the resources required for support are directly proportional to the number of machines requiring support. In other implementations, such as where there is no financial component to the relationship, the number of machines for a single subscription may be quire large.

The subscriber want to invite someone to be a support contact. The subscriber can invite someone to be a support contact in a variety of ways. For example, when a user signs-up to be a subscriber, the user may specify one or more support contacts. Alternatively, the one or more support contacts could be added later. The subscriber accesses the website and signs-in. Upon sign-in, the subscriber is presented with a link to add a support contact. The subscriber adds the support contact by providing the support contact's email address, an instant message address, or some other identifier. The support service indicates that an invitation will be sent to the support contact, and at that point the support contact is identified to the subscriber as an invited support contact.

The invited support contact receives the invitation. If the invitation is an email, the email may include a link for accepting the invitation. A GUID is embedded within the invitation in order to identify the support contact to the support service. The support contact accesses the website and signs-in using the authentication manager 552 and third-party authentication 670. If the support contact does not have an account with the third-party authentication 670, the support contact is instructed to create an account and return.

On initial sign-in, the support contact is asked to accept the terms of use for being a support contact using support service 500. The support contact also provides personal information, such as a friendly name and a contact email address if different from the address used for initial contact. If desired, the support contact may choose to receive alerts from the support service when certain conditions occur at the client/subscriber that require the support contact's attention. When the support contact has completed the this portion of the registration process, the support contact may be shown a web page explaining further details about the support service, features the support service offers, and the responsibilities of a support contact.

Following a successful acceptance of the invitation, the support contact shows up as an active support contact on the subscribers list of support contacts. From this point on, the support contact is granted access as a support contact to all of the machines associated with the subscriber. If the acceptance does not occur within a predetermined time period, the invitation may expire. Following expiration, if the support contact attempts to accept the invitation, the support contact is given a message that another invitation must be received. The number of support contacts allowed for a subscriber may be limited to some predetermined number.

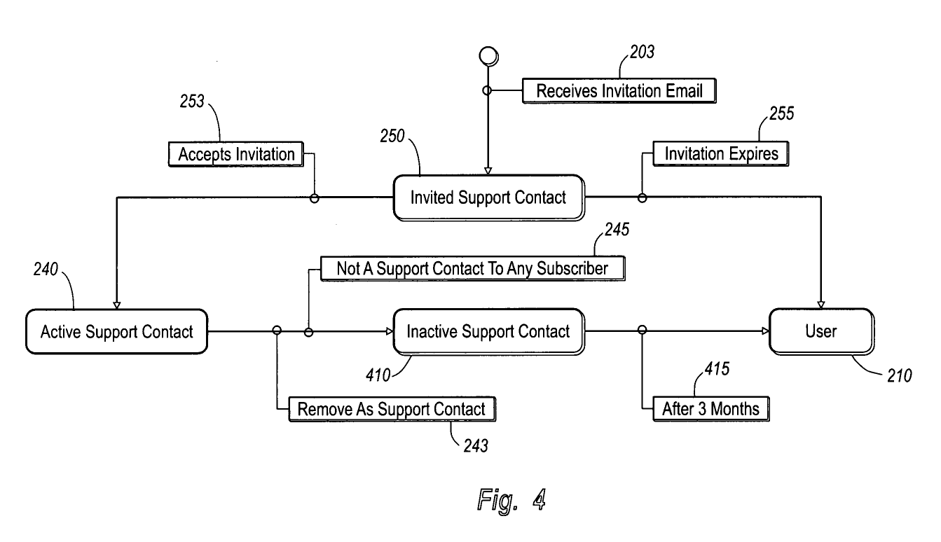

FIG. 4 is a state diagram for a support contact. As indicated above, a support contact who has received an invitation is designated as an invited support contact 250. If the invited support contact accepts the invitation 253, the support contact is designated as an active support contact 240. It should be noted that generally, when the term “support contact” is used in this application, it refers to an active support contact. If an active support contact is no longer a support contact for any subscriber 245, such as from having been removed as a support contact 243 from all subscribers, the support contact is designated as an inactive support contact 410. After a predetermined period of time 415, such as three months, the support contact becomes a user 210. As shown in FIG. 4, if an invited support contact fails to accept an invitation prior to expiration of the invitation 255, the invited buddy is also designated as a user 210. The states shown in FIG. 4 are relative to a single subscriber.

The subscriber's health meter turns red. The subscriber decides to turn off firewall protection because she is not able to use an application and does not know how to modify the firewall policy. The health meter changes to red due to the potential security risk. (As indicated above, the health meter may take a variety of forms, including a range of colors and/or numbers.) As a result the support contact receives an alert to indicate that the subscriber machine's health meter has change to red because the firewall has been disabled. The support contact calls the subscriber to find out why the subscriber has disabled the firewall and explains how to add the application to the firewall policy and then enables the firewall. Note that in this and other ways, the support service takes a proactive role in identifying and addressing potential problems before they become more critical (e.g., waiting for a virus infection or security breach before determining the cause of the vulnerability).

The support contact wants to configure/modify the support contact's profile. The support contact signs-in to the support service website. Once signed in the support contact can turn alerts on or off, depending on preference. The support contact can modify the associated friendly name and contact email or other address. If the support contact modifies the contact email address, an email will be sent to the specified email address for confirmation. The support contact will then need to sign-in using a verification link in the email to confirm the email address change.

Support contact termination. Support contacts may be terminated in three ways: the subscriber may no longer wish to use the support contact, the subscriber's subscription may be terminated, or the support contact may no longer wish to support the subscriber. When the subscriber terminates the relationship or the subscriber's subscription is terminated for some reason (e.g., subscriber no longer wish to pay for the service), the support contact receives a message indicating that access as a support contact to the subscriber's machines has been terminated. The message may also indicate the reason for termination. The message may request that the support contact take certain actions to simplify the termination process.

The subscriber may terminate the support contact from the support website. After sign-in, the subscriber selects a link to show a list of all support contacts for the subscriber. The list, for example, could include friendly names and email addresses. The subscriber selects and removes the support contact from the list. In some implementations, a confirmation for removing the support contact is shown. As indicated above, once the removal is confirmed, an email is sent to the support contact indicating that the subscriber has dropped the support contact. The subscriber may remove the support contact even if the support contact has not accepted the invitations (i.e., the support contact is only an invited support contact). If the support service has not yet sent the invitation to the support contact at the time of removal, then no messages are sent.

The subscribers use of the support service may be terminated for a variety of reasons. For example, the subscriber may have provided a credit card that is no longer valid. After termination, the support contact receives a message indicating that the subscriber's subscription has been terminated. Usually, under these circumstances, the email will not contain any information regarding the reason for termination.

The support contact also may wish to terminate the relationship. Following sign-in to the support service website, the support contact is shown a list of subscribers (and machines for each subscriber) for which the support contact provides support. The support contact can select and remove the subscriber from the list. A confirmation for terminating as a support contact for the subscriber is shown. Once the confirmation is made, a message is sent to the subscriber indicated that the support contact no longer monitors the subscriber's machine.

Embodiments of the present invention may comprise one or more special purpose and/or one or more general purpose computers including various computer hardware, as discussed in greater detail below. Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disc storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection or interface (either hardwired, wireless, or a combination of hardwired or wireless) to a computer, the computer properly views the connection or interface as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

### II. Example Support Service

FIG. 5 is a block diagram of an example support service 500 in accordance with the present invention. Support service 500 includes a client servicing system 510 and a subscriber registration system 550. FIG. 5 also shows a support contact 100, a network cloud 610 that includes various services that are not necessarily part of the support service 500, but may be part of a larger, network, such as a private or public network, and a client/subscriber 700. Note that network cloud 601 includes an authentication 670 component, an alert 680 component, and an email system component 690. The alert 680 component may be part of an instant messaging system.

Subscriber registration system 550 includes an authentication manager 552 for interacting with the authentication 670 component in the network cloud 601 with support contact 100 or client subscriber 700 sign-in to subscriber and support websites 562. In one implementation, authentication 670 component represents a third-party authentication system. Of course, in other implementations, the authentication may be integrated into subscriber registration system 550 and/or subscriber and support websites 562.

The subscriber and support websites 562 are example implementation for the activities described above. In addition to registration, the support contact 100 and the client/subscriber 700 communicate with each other through support service 500 and these websites.

The support contact profile manager 572 manages information for the support contact 100, including status information related to the support contact and the support contact's profile. The information for support contact 100 is stored in support contact store 574. Status information includes the states identified in FIG. 4 for support contact, as well as other information. The support contact's profile includes all the relevant information for the support contact, such as friendly name, contact addresses, and so forth. Information about client/subscriber 700 is stored in subscriber store 592.

Client servicing system 510 accumulates and analyzes support parameters received from client/subscriber 700, and providing the support parameters to the support contact 100 through subscriber and support websites 562. The support parameters also may be provided to the support contact 100 through alerts 680 and email system 690, as described in more detail below.

Messaging telemetry system 542 is responsible for interacting with client/subscriber 700 when exchanging telemetry data. Message telemetry system 542 is also responsible for sending support actions to client/subscriber 700. For example, when support contact 100 identifies actions to be taken at the client, these actions are sent to the client/subscriber 700 through messaging telemetry system 542. The actions may take the form of a script, published by action script publisher 524 or may simply be a list of instructions to the subscriber. The scripts are prepared by action scripts receiver 522 based on information, potentially in the form of one or more action scripts 565, received from the subscriber and support websites 562 based on input received from support contact 100. Prior to being sent to the client/subscriber 700, the scripts are stored in the alerts store 532.

The telemetry data (support parameters 513) received from client/subscriber 700 are stored in stat store 514. Stat retriever 512 provides the support parameters to the subscriber and support websites 562 where they can be accessed by support contact 100 for review and analysis. Stat store monitor 516 monitors incoming support parameters and provides them to the alerts store 532 for processing by the alerts manager 534. Alerts manager 534 analyzes information in the alerts store to determine in the received support parameters merit sending an alert to the support contact 100, who otherwise is not made aware of the support parameters until visiting the subscriber and support websites 562. As shown, the alerts manager may send alerts to the support contact though an email interface 526 or through an alerts interface 536. Alerts interface 536 may correspond to an instant or text message alert system.

### III. Example Distributed Service Delivery Environment

FIG. 6 illustrates an example distributed service delivery environment suitable for use in practicing the present invention. The description of FIG. 6 begins with a high-level introduction of the components that make up the distributed service delivery model, followed by a more detailed description of how the components interact with each other.

The example distributed service delivery environment illustrated in FIG. 6 includes a network-cloud 601, root silo 600, a client 700, and one or more servicing silos 500, 502, all communicating over network connections 610, 620, 630, 640, 650, and 660. The design provides for scaling and operating a highly distributed service delivery environment over a network, such as the Internet, and allows for a high level of reliability by minimizing the need for communication between service components. In terms of scale, the design facilitates the hosting of multiple service instances, which as described in greater detail below, can be used to scale-up system capacity or to federate a service across multiple service providers. The model also provides a mechanism for separating personally identifiable information (PII) from day-to-day servicing information. Examples of PII include name, address, phone number, credit card number, email address, demographic information, other subscriptions, subscription history and so forth.

Root silo 600 provides entitlement, provisioning, and PII storage services for the entire client base. Servicing silo 500 provides the day-to-day service interactions with clients and provides storage for servicing related data. Client 700, as entitled and provisioned by root silo 600, is serviced on a day-to-day basis through servicing silo 500. An administrative feature, which may be integrated with the root silo or implemented as a separate silo, determines day-to-day service operation and provides an aggregated view of the overall service status.

A servicing certificate 624 contains service entitlement information, information to identify the location of an assigned servicing silo, and one or more keys, such as a public/private key pair, for secure communication between the client, the root silo, and the servicing silo. A set of inter-silo communication channels 610 and 660 allow the servicing silos and the root silo to communicate with each other. Servicing silo configuration information 654 allows the servicing silo to configure the client side of a service. Servicing actions 614 provide basic management capabilities for operating the overall system.

### A. Separation of Personally Identifiable Information and Servicing Related Data

One principle behind the distributed service delivery model of the present invention is the separation of systems that process personally identifiable information (“PII”) related to registration and/or billing activities from servicing related data and processing. From a data perspective, the most sensitive data, especially billing related information, is kept within the root silo 600, which is responsible for registration, entitlement, and billing services. In contrast, the day-to-day servicing of a client is performed by a servicing silo 500, which includes activities such as managing client updates, processing client telemetry and providing web related interfaces for viewing a client's status, as described above in connection with FIG. 5. Depending on the desired scale, multiple servicing silos may be operated with the single root silo being responsible for provisioning or assigning clients to a specific servicing silo.

A multiple servicing silo design supports at least three scenarios: scaling-out, geographical distribution, and OEM or other federation. Scaling-out relates to having multiple servicing silos within a single data center or geographical location. Geographical distribution relates to having geographically diverse servicing silos, some of which also may be scaled-out. Federation relates to having diverse operators responsible for the servicing silos, some of which may be geographically diverse and/or: scaled-out. Of course, none of these scenarios is mutually exclusive, and other scenarios are possible depending on the goals and requirement for a particular implementation.

### B. Messaging Design

Because the design allows for multiple servicing silos, attention is given to the operational dependencies between the root silo and the servicing silos as well as silo-to-silo dependencies. In other words, to achieve a high level of reliability, transactions should not span multiple silos. Servicing silo 500, for example, should not need to contact the root silo 600 for an entitlement check before granting access to a service at the servicing silo. In order to meet this design goal, the client acts as a hub for communication and carries or stores all of its configuration and entitlement information.

In one embodiment, messages are extensible Markup Language (“XML”) messages supported by a public key infrastructure (“PKI”) system that provides security and entitlement. In other words, silos communicate via signed XML messages, with the client acting as a go-between when needed, with most transactions being asynchronous. In addition, the client 700 maintains a digital certificate, in a servicing certificates database, that was issued by the root and identifies the servicing silo to which the client is assigned, as well as the services to which it has access or with which the client may interact. The PKI system allows both the clients and silos to validate messages to ensure they are authentic. Authenticity is important particularly for sensitive messages, like configuration changes, end-user targeted communications, and re-provisioning changes.

### C. Client, Root Silo, and Servicing Silo Interaction

Servicing silo 500 is registered as a potential provider of one or more services for clients. Once registered, servicing silo 500 is managed within the overall distributed service delivery environment through servicing actions 614, and root silo 600 is in a position to begin assigning clients to the servicing silo for the services it provides.

Client 700 directs a request 622 to the root silo 600 for interaction with a service, such as a technical support service described above. Directing a request may include generating the request and sending it to the root silo 600. The root silo 600 receives the request from the client 700 and identifies servicing silo 500 as an available provider of the service. Where multiple servicing silos are capable of providing the service, a particular servicing silo may be identified, based at least in part, on the geographic location of the client and/or the servicing silo. Alternatively, the client 700 may express a preference for a particular servicing silo, perhaps where multiple entities are responsible for providing the service and the client has, an existing relationship, more confidence in, or some other motivation for preferring a particular servicing silo. The preference also could be based on client hardware and/or software, such as in identifying a particular servicing silo that is associated with an OEM for or reseller of the hardware and/or software.

The request may represent an initial request for interaction with the service or represent a request to renew interaction with the service that has expired. For example, the request may be to interact with some antivirus software in order to protect the client—either to install the antivirus software initially, update previously installed antivirus software, or renew a subscription for antivirus software updates that is expired or that will expire in the future.

Client 700 also may provide PII to the root silo 600, which the root silo receives, and may store and use, for example, in billing for the client's interaction with the service. Providing PII to the root silo 600 may include collecting the PII and sending it to the root silo.

Root silo 600 generates a servicing certificate 624 that contains (i) service entitlement information showing that the client is entitled to interact with the service at the identified servicing silo, (ii) location information identifying the location of the servicing silo, the location information could include, for example, an address or uniform resource locator, and (iii) one or more keys, such as a private/public key pair, for use in secure communication between the client 700, the servicing silo 500, and/or the root silo 600. The servicing certificate also may contain expiration information defining a term during which the client is authorized to interact with the service.

For services that include multiple service levels or tiers, the servicing certificate may contain an identifier for a particular service level or tier to which the client is entitled. For instance, with reference to the antivirus software example given above, a variety of levels and/or types of protection may be available (antivirus, spyware, firewalls, etc.), and the particular level of interaction allowed by the servicing certificate may be identified as a service level or tier within the antivirus service.

Root silo 600 sends the servicing certificate 624 to the client for the client to use when interacting with the service at the servicing silo 600. The client 700 acquires the servicing certificate 624 from the root silo 600 and directs a request to the servicing silo 500 for interaction with the service using the location information in the servicing certificate. Acquiring the servicing certificate 624 may include receiving the servicing certificate from the root silo 600, and directing a request to the servicing silo 500 may include generating the request and sending it to the servicing silo 500. The client 700 provides the servicing certificate to the servicing silo 500 to show that the client is entitled to interact with the service at the servicing silo, and then interacts 652 with the service at the servicing silo.

Interaction with the servicing silo 500 may include receiving configuration information 654 from the servicing in order to configure the client for interacting with the servicing silo. Interaction with the servicing silo 400 also may include sending client telemetry data to the service at the servicing silo for analysis. Telemetry data is a broad term used to describe information about the state or condition of the client. The telemetry data include support parameters, such as for example, operating system version, whether antivirus software is running and if so when the antivirus software was last updated, were any threat detected and if so were the threat cleaned successfully, whether backup are being performed at the client, whether firewall protection is enabled at the client, when the last software update was applied, particular events generated by client components, error conditions encountered by client software, unhandled issues related to particular client features (i.e. new backup file extensions), startup time of the system, last defragmentation of hard drive, and so forth, and so forth.

At times, it may be necessary to move a client 700 from one servicing silo to another, such as because the servicing silo is not operating accordingly to agreed standards or as part of a redistribution based on the availability of new servicing silos, etc. When moving a client 700, the root silo 600 generates a new servicing certificate that, similar to the prior servicing certificate, contains (i) service entitlement information showing that the client is entitled to interact with the service at the new servicing silo, (ii) location information identifying the location of the new servicing silo, and (iii) one or more keys for using in secure communication between the client, the new servicing silo, and the root silo. The root silo 600 sends the new servicing certificate to the client for the client to use when interacting with the service at the new servicing silo, in order to move the client from the prior servicing silo to the new servicing silo.

The servicing silo 500 receives, through the client 700, provisioning data created by the root silo 600 so that the servicing silo can allocate and initialize storage for the client. The servicing silo 500 also receives at least a portion of the servicing certificate. Servicing silo 500 may send broadcast message to multiple clients authorized to interact with a service at the servicing silo and may send targeted messages to one or more individual clients.

When the servicing silo 500 receives telemetry data from the client 700, the servicing silo may aggregate the telemetry data and forward or report 612 the aggregated telemetry data to an administrative silo for analysis. The telemetry data received from the client 700 may be formatted in eXtensible Markup Language (“XML”) and signed by at least on of the one or more keys to show that the telemetry data was sent by the client. The servicing silo 500 may provide a machine view of the telemetry data received from the client for access by others. Furthermore, the servicing silo 400 may associate a third party support entity with the client, analyze the telemetry data received, and notify the third part support entity of one or more support issues identified while analyzing the telemetry data. For example, the telemetry data may indicate a performance or security issue at the client that should be remedied.

It should be noted that not all servicing information is necessarily kept at the servicing silo 500. For scale, performance, and availability reasons, certain types of content may be stored on one or more cached download servers, such as distributed edge cache server or virus definition service, across a network cloud, such as the Internet. This architecture is fairly common and used by services that provide a significant volume of downloads, such as services for updating an operating system with patches. The content also may include client install and update bits, antivirus signatures, firewall policies, etc. One benefit that a distributed edge cache server offers is that it allows an operating system vendor to maintain control over certain aspects of the client, when an OEM is hosting the servicing silo, in order to assure a consistent level of service for all customers. It also eliminates the potential threat of a rogue servicing silo delivering malicious or out-of-date content related to the operating system.

The network cloud 601 also may include a subscription platform system for billing activities in cooperation with root silo 600.

### IV. Example Client Components

FIG. 7 is a block diagram of components within the example client/subscriber 700 illustrated in FIGS. 1 and 6, including a variety of services clients 710, such as telemetry client 730, antivirus client 750, and other clients 760.

The digital certificate issued by the root silo's entitlement system controls the servicing silo to which a client is assigned. However, each silo usually has additional configuration information related to the services hosted within the silo. This servicing silo configuration information may comprise an eXensible Markup Language (“XML”) fragment that is signed by the servicing silo's key. Having separate servicing silo configuration information allows the servicing silo's operators to manage the configurations of the services hosted within the silo in a dynamic manner. For example, the frequency of the client's heartbeat or the uniform resource locator/address for uploading telemetry data may be dynamically configured. Because the XML configuration is digitally signed, the client is able to verify that the configuration information has not been altered.

The servicing silo configuration information is installed on the client as part of the provisioning process in service configuration information db 720. At service startup, the client loads the digital certificate assigned to it by the root silo and stored in servicing certificate(s), db 740, and then checks to see if it has the corresponding service silo configuration information. If not, which is the case during installation, the client sends a signed request to the servicing silo for its configuration information. The returned silo-configuration information is verified, and then stored locally in service configuration information db 720. When the client loads the servicing silo configuration information, it verifies the signature on the file before accepting any of its parameters. Error conditions may be handled by a set of default configuration settings as well as additional attempts to contact the assigned servicing silo or the root silo.

Telemetry client 730 and telemetry manager 734 allow for the collection of telemetry data from client 700. Among other things, telemetry manager 734 uses service configuration information db 720 to determine what telemetry data should be collected and stored in telemetry data db 732 as well as how often the telemetry data should be uploaded to the servicing silo.

Antivirus client 750 determines whether antivirus software at client 700 is up to date and downloads new antivirus software from a servicing silo as appropriate. The status of the antivirus software also may be included in the telemetry data as an indication of the state of the machine, independent of the update feature provided by antivirus client 750.

A variety of other clients 760 may be developed for the distributed service delivery model in general and for client 700 in particular. The present invention is not necessarily limited to any particular services, but rather is directed toward the distributed service delivery model that allows services to be developed and deployed in an effective manner.

### V. Example Hardware Environment

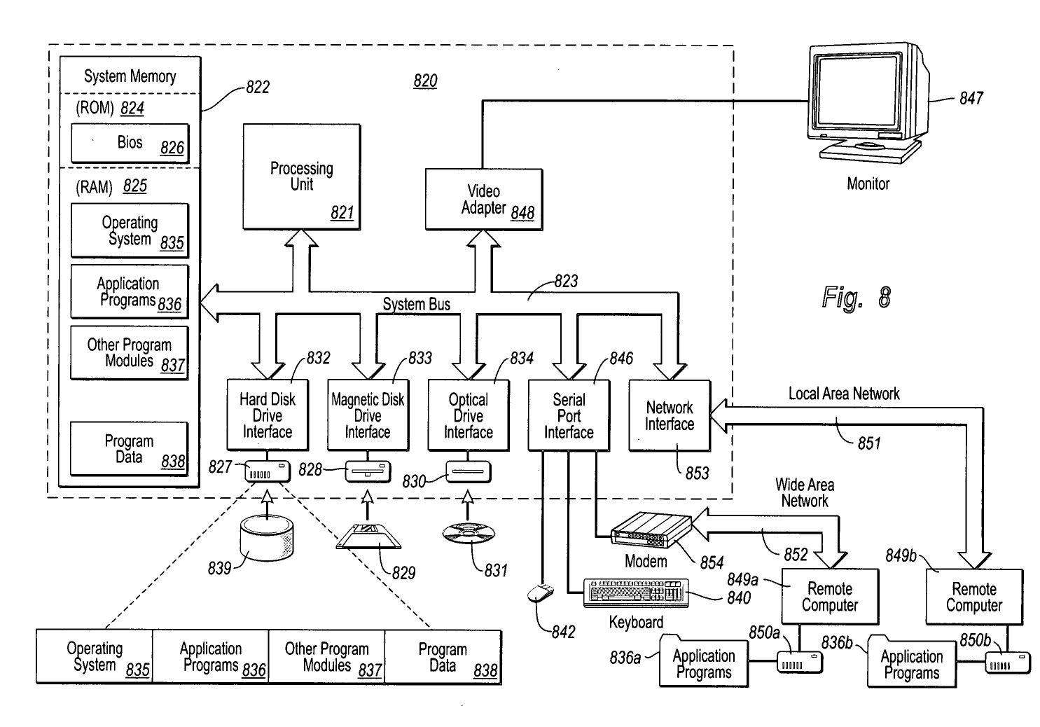

FIG. 8 and the following discussion are intended to provide a brief, general description of a suitable computing environment in which the invention may be implemented. Although not required, the invention will be described in the general context of computer-executable instructions, such as program modules or software components, being executed by computers in network environments. Generally, program modules or software components include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those skilled in the art will appreciate that the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 8, an exemplary system for implementing the invention includes a general purpose computing device in the form of a conventional computer 820, including a processing unit 821, a system memory 822, and a system bus 823 that couples various system components including the system memory 822 to the processing unit 821. The system bus 823 may be any of several types of bus structures including a memory bus or memory controller, a peripheral bus, and a local bus using any of a variety of bus architectures. The system memory includes read only memory (ROM) 824 and random access memory (RAM) 825. A basic input/output system (BIOS) 826, containing the basic routines that help transfer information between elements within the computer 820, such as during start-up, may be stored in ROM 824.

The computer 820 may also include a magnetic hard disk drive 827 for reading from and writing to a magnetic hard disk 839, a magnetic disk drive 828 for reading from or writing to a removable magnetic disk 829, and an optical disc drive 830 for reading from or writing to removable optical disc 831 such as a CD-ROM or other optical media. The magnetic hard disk drive 827, magnetic disk drive 828, and optical disc drive 830 are connected to the system bus 823 by a hard disk drive interface 832, a magnetic disk drive-interface 833, and an optical drive interface 834, respectively. The drives and their associated computer-readable media provide nonvolatile storage of computer-executable instructions, data structures, program modules and other data for the computer 820. Although the exemplary environment described herein employs a magnetic hard disk 839, a removable magnetic disk 829 and a removable optical disc 831, other types of computer readable media for storing data can be used, including magnetic cassettes, flash memory cards, digital versatile discs, Bernoulli cartridges, RAMs, ROMs, and the like.

Program code means comprising one or more program modules may be stored on the magnetic hard disk 839, removable magnetic disk 829, removable optical disc 831, ROM 824 or RAM 825, including an operating system 835, one or more application programs 836, other program modules 837, and program data 838. A user may enter commands and information into the computer 820 through keyboard 840, pointing device 842, or other input devices (not shown), such as a microphone, joy stick, game pad, satellite dish, scanner, or the like. These and other input devices are often connected to the processing unit 821 through a serial port interface 846 coupled to system bus 823. Alternatively, the input devices may be connected by other interfaces, such as a parallel port, a game port or a universal serial bus (USB). A monitor 847 or another display device is also connected to system bus 823 via an interface, such as video adapter 848. In addition to the monitor, personal computers typically include other peripheral output devices (not shown), such as speakers and printers.

The computer 820 may operate in a networked environment using logical connections to one or more remote computers, such as remote computers 849a and 849b. Remote computers 849a and 849b may each be another personal computer, a server, a router, a network PC, a peer device or other common network node, and typically include many or all of the elements described above relative to the computer 820, although only memory storage devices 850a and 850b and their associated application programs 836a and 836b have been illustrated in FIG. 8. The logical connections depicted in FIG. 8 include a local area network (LAN) 851 and a wide area network (WAN) 852 that are presented here by way of example and not limitation. Such networking environments are commonplace in office-wide or enterprise-wide computer networks, intranets and the Internet.

When used in a LAN networking environment, the computer 820 is connected to the local network 851 through a network interface or adapter 853. When used in a WAN networking environment, the computer 820 may include a modem 854, a wireless link, or other means for establishing communications over the wide area network 852, such as the Internet. The modem 854, which may be internal or external, is connected to the system bus 823 via the serial port interface 846. In a networked environment, program modules depicted relative to the computer 820, or portions thereof, may be stored in the remote memory storage device. It will be appreciated that the network connections or interfaces shown are exemplary and other means of establishing communications over wide area network 852 may be used.

We claim:

1. A computer program product for a distributed computer system comprising one or more clients, one or more support contacts that provide technical support to the one or more clients, and a support service that communicates information between the one or more clients and the one or more support contacts, the computer program product comprising one or more computer readable media with computer executable instructions that implement a method of monitoring operation of a client for use in providing technical support to the client, the method comprising the client performing acts of:
sending registration information to the support service for registering a user as a subscriber with the support service for the client;
identifying a support contact to the support service;
tracking one or more support parameters;
uploading the one or more support parameters to the support service for analysis and distribution to the support contact;
receiving support data from the support service, the support data including one or more support actions having been determined by the support contact based on the one or more support parameters uploaded to the support service; and
taking the one or more support actions included in the support data.

2. A computer program product as recited in claim 1, wherein the support data comprises one or more scripts or identifies one or more programs to be run at the client.

3. A computer program product as recited in claim 1, wherein the one or more support parameters comprise at least one of (i) an indication whether virus protection is on at the client, (ii) an indication whether virus protection is up-to-date at the client, (iii) an indication whether one or more critical updates are installed at the client, (iv) an indication whether firewall protection is on, (v) an indication of when the last complete virus scan was performed, (vi) an indication of the results of the last virus scan, or (vii) an indication of when the last backup of the client was performed.

4. A computer program product as recited in claim 1, the method further comprising acts of:
tracking one or more additional support parameters after taking the one or more support actions, the one or more additional support parameters indicating whether the one or more support actions were taken; and
uploading the one or more additional support parameters to the support service for analysis and distribution to the support contact.

5. A computer program product as recited in claim 1, wherein one or more other clients are registered with the support service for the subscriber, the method further comprising acts of:
authenticating to the support service as the subscriber; and
downloading at least one support parameter for each of the clients registered with the support service for the subscriber.

6. A computer program product as recited in claim 1, wherein the client has identified one or more other support contacts to the support service, the method further comprising an act of downloading a list of the support contacts for review.

7. A computer program product as recited in claim 1, the method further comprising an act of indicating to the support service that the subscriber no longer wishes the support contact to provide support in order to stop the support service from distributing any further support parameters to the support contact.

8. A computer program product for a distributed computer system comprising one or more client subscribers, one or more support contacts that provide technical support to the one or more clients, and a support service that communicates information between the one or more client subscribers and the one or more support contacts, the computer program product comprising one or more computer readable media with computer executable instructions that implement a method of tracking one or more support parameters for use in providing technical support to a client subscriber, the method comprising the support service performing steps for:
registering a user as a subscriber with the support service for a client;
associating one or more support contacts with the subscriber, the one or more support contacts having been identified by the subscriber;
accumulating one or more support parameters from the client;
providing the one or more support parameters to the one or more support contacts;
accumulating one or more support actions from the one or more support contacts in response to the one or more support parameters;
generating support data that includes the one or more support actions; and
providing the support data to the client.

9. A computer program product as recited in claim 8, the method further comprising acts of:
analyzing the one or more support parameters accumulated from the client;
sending an alert to the one or more support contacts based on the analysis of the one or more support parameters.

10. A computer program product as recited in claim 8, wherein the step for accumulating the one or more support parameters comprises an act of periodically receiving the one or more support parameters from the client.

11. A computer program product as recited in claim 8, wherein the step for associating one or more support contacts with the subscriber comprises acts of:
receiving an identifier for each of the one or more support contacts from the subscriber;
inviting each of the one or more support contacts to be a support contact for the subscriber; and
receiving an acceptance from at least one of the one or more support contacts to be a support contact for the subscriber.

12. A computer program product as recited in claim 11, the method further comprising acts of:
receiving personal information for the at least one of the one or more support contacts; and
receiving an indication that the at least one of the one or more support contacts desires to receive any alerts generated in response to analyzing the one or more support parameters accumulated from the client.

13. A computer program product as recited in claim 8, the method further comprising an act of receiving an indication from the subscriber to terminate at least one of the one or more support contacts as a support contact for the subscriber.

14. A computer program product as recited in claim 8, wherein at least one of the one or more support contacts is a support contact for multiple subscribers, the method further comprising acts of:
sending a list of the multiple subscribers to the at least one of the one or more support contacts;
receiving an indication from the at least one of the one or more support contacts to be removed as a support contact for the subscriber; and
removing the association of the at least one of the one or more support contacts with the subscriber.

15. For distributed computer system comprising a plurality of clients, one or more support contacts that provide technical support to the plurality of clients, and one or more support services that communicate information between the plurality of clients and the one or more support contacts, a support service comprising:
a network interface for communicating with the one or more clients and the one or more support contacts;
one or more computer readable media with computer executable instructions, the computer executable instructions comprising:
computer executable instructions for registering a user as a subscriber with the support service for a client;
computer executable instructions for assigning one or more support contacts to the subscriber;
computer executable instructions for receiving one or more support parameters from the client;
computer executable instructions for sending the one or more support parameters to the one or more support contacts;
computer executable instructions for receiving one or more support actions from the one or more support contacts based on the one or more support parameters; and
computer executable instructions for sending the one or more support actions to the client; and
a processing unit coupled to the network connection and the one or more computer readable media for sending and receiving data over the network connection and for executing the computer executable instructions.

16. A support service as recited in claim 15, the computer executable instructions further comprising:
computer executable instructions for analyzing the one or more support parameters received from the client;
computer executable instructions for determining that an alert should be sent to the one or more support contacts assigned to the subscriber; and
computer executable instructions for sending an alert to the one or more support contacts based on the analysis of the one or more support parameters.

17. A support service as recited in claim 15, the computer executable instructions further comprising computer executable instructions for authenticating the subscriber and the one or more support contacts.

18. A support service as recited in claim 15, the computer executable instructions further comprising:
computer executable instructions for inviting each of the one or more support contacts to be a support contact for the subscriber; and
computer executable instructions for receiving an acceptance from at least one of the one or more support contacts to be a support contact for the subscriber.

19. A support service as recited in claim 15, wherein the one or more support actions are sent to the client in the form of a script to be executed at the client.

20. A support service as recited in claim 15, wherein the one or more support parameters correspond to a security status of the client, a health status of the client, or both the security status and the health status of the client:
